(19) United States
(12) Patent Application Publication
(10) Pub. No.: US 2009/0241288 A1
(43) Pub. Date: Oct. 1, 2009

(54) Snap hinge for supporting a closure element

(76) Inventor: Daniele Zetti, Modena (IT)

Correspondence Address: MODIANO & ASSOCIATI, Via Meravigli, 16, Milano, 20123, IT

(21) Appl. No.: 12/382,582

(22) Filed: Mar. 19, 2009

(30) Foreign Application Priority Data
Mar. 27, 2008 (IT) MO2008A000087

(51) Int. Cl. E05D 7/04

(52) U.S. Cl. 16/236; 16/235

(57) ABSTRACT

A snap hinge for supporting a closure element comprising a first articulated quadrilateral and a second articulated quadrilateral, sharing a first and a second lever having as a base element respectively a plate for coupling to a fixed element and a plate for fixing to a closure element, elastic elements acting between a point of the first lever and a point of the second lever and auxiliary elastic elements are arranged in series to the elastic elements and have opposite ends that are articulated to the first lever to a first pivot supported by a supporting element jointly associated with the fixing plate. The supporting element comprises at least one strip and one pair of first flaps formed so as to protrude from two opposite edges of the strip and provided with holes for the opposite ends of the first pivot. The strip is substantially inclined with respect to the plane of arrangement of the coupling plate.

### BACKGROUND OF THE INVENTION

In the field of furniture, it is known to use snap hinges that are adapted to turn a closure element about a substantially horizontal or inclined axis, such as for example snap hinges used to open and close doors on cabinets arranged inside caravans or the like.

Known snap hinges comprise a first articulated quadrilateral and a second articulated quadrilateral, which share a first lever and a second lever and in which the base element is respectively a plate for coupling to a fixed element of a piece of furniture or the like and a plate for fixing to the closure element.

Further, known snap hinges comprise a first spring, which acts between two mutually opposite points of one of the two articulated quadrilaterals, and a second spring, which is arranged in series to the first one.

Each one of the two articulated quadrilaterals is constituted by the first and second levers, by an arm and by a base element, respectively, the coupling plate or the fixing plate, which are mutually articulated. The spring acts between a contact and articulation point on the first lever and a contact and articulation point on the second lever.

The fixing plate is anchored to the door on the surface designed to face the compartment of the cabinet in the configuration in which the door is closed.

The fixing of the coupling plate and of the fixing plate occurs generally by way of threaded means such as screws.

In the open configuration, the spring of the snap hinge acts in contrast with the weight force of the door and therefore has the function of supporting such door.

In the closed configuration, the elastic action applied by the spring is adapted to keep the door in a position for closing the compartment of the cabinet.

In particular, two different types of snap hinge are known: in the first one, the first spring is anchored directly to the coupling plate.

In such hinges, the plate for coupling to the fixed structure of a piece of furniture or the like is bridge-shaped and has a compartment for accommodating such first spring.

In particular, the coupling plate, in this first known type of snap hinge, is such that it can be anchored to the fixed element, which is constituted by a cross-member that is fixed to the wall and delimits in an upper region the cabinet. The crossmember, in particular, is generally substantially perpendicular to the wall and therefore the bridge-like coupling plate is arranged, in the configuration in which the door is open, on a plane of arrangement that is substantially perpendicular to the fixing plate.

This first known type of snap hinge, however, is not free from drawbacks, which include the fact of having large space occupations especially in the region formed by the coupling plate, which must accommodate the first spring inside it.

Accordingly, the cross-member to which the hinge is fixed must be wide enough to accommodate the coupling plate, thus reducing the useful volume of the cabinet or of the opening for accessing it.

Again with reference to furniture, such as cabinets, for the internal furnishing of caravans or the like, a second type of snap hinge is known in which the coupling plate can be anchored exclusively directly to the wall that delimits in an upper region the cabinet and on the surface that can face the compartment of such cabinet.

The fixing plate, as described above, is anchored to the door on the surface that is designed to face the compartment of the cabinet in the configuration in which the door is closed.

The same coupling plate is arranged, in the open configuration of the door, on a plane of arrangement that is substantially parallel to the fixing plate.

In these known types of hinge, the first spring is articulated to the coupling plate by interposing a supporting element.

The supporting element comprises, in particular, a strip provided with flaps for supporting a pivot to which the first spring is articulated.

In such hinge, the strip is parallel to the coupling plate and is coplanar thereto.

Also this second type of snap hinge, while ensuring a good seal of the closure and practicality in use and installation, is not however free from drawbacks, which include the fact that the coupling plate, as provided, is not suitable for fixing to the fixed element when said fixed element is constituted by the cross-member that is fixed to the wall that delimits in an upper region the cabinet, since as mentioned earlier the cross-member is generally substantially perpendicular to the wall.

For these cabinets provided with the cross-member, it is therefore necessary to install a different type of hinge, as indicated above, with the drawbacks mentioned above.

### SUMMARY OF THE INVENTION

The aim of the present invention is to eliminate the above-mentioned drawbacks of known hinges, by providing a snap hinge that allows stable and safe support of a closing element with respect to the structure of a piece of furniture or the like both in a closed configuration and in an open configuration of the hinge, while limiting its structural complexity and at the same time reducing its space occupation.

Within this aim, an object of the present invention is to provide a snap hinge that has good dimensional compactness and at the same time is suitable for fixing to the fixed element when said fixed element is constituted by the cross-member that is fixed to the wall that delimits said cabinet in an upper region.

Another object of the present invention is to provide a snap hinge that is simple, relatively easy to provide in practice, safe in use, effective in operation, and of relatively low cost.

This aim and these and other objects, which will become better apparent hereinafter, are achieved by the present snap hinge for supporting a closure element comprising a first articulated quadrilateral and a second articulated quadrilateral, which share a first lever and a second lever, said first and second levers having as a base element respectively a plate for coupling to a fixed element and a plate for fixing to a closure element, elastic means which act between a point of said first lever and a point of said second lever and auxiliary elastic means which are arranged in series to said elastic means and have an end that is articulated to said first lever and the opposite end that is articulated to a first pivot that is supported by a supporting element that is jointly associated with said fixing plate, said supporting element comprising at least one strip and one pair of first flaps that are formed so as to protrude from two opposite edges of said strip and are provided with holes for supporting the opposite ends of said first pivot, characterized in that said strip is substantially inclined with respect to the plane of arrangement of said coupling plate.

### BRIEF DESCRIPTION OF THE DRAWINGS

Further characteristics and advantages of the present invention will become better apparent from the following detailed description of a preferred but not exclusive embodiment of a snap hinge for supporting a closure element, illustrated by way of non-limiting example in the accompanying drawings, wherein:

FIG. 1 is a side view of a hinge according to the invention in a configuration for closing the cabinet;

FIG. 2 is a side view of the hinge according to the invention in a configuration for opening the cabinet;

FIG. 3 is a sectional view of the hinge of FIG. 1;

FIG. 4 is a sectional view of the hinge of FIG. 2;

FIG. 5 is a perspective view of the hinge according to the invention;

FIG. 6 is an exploded perspective view of a detail of the hinge according to the invention.

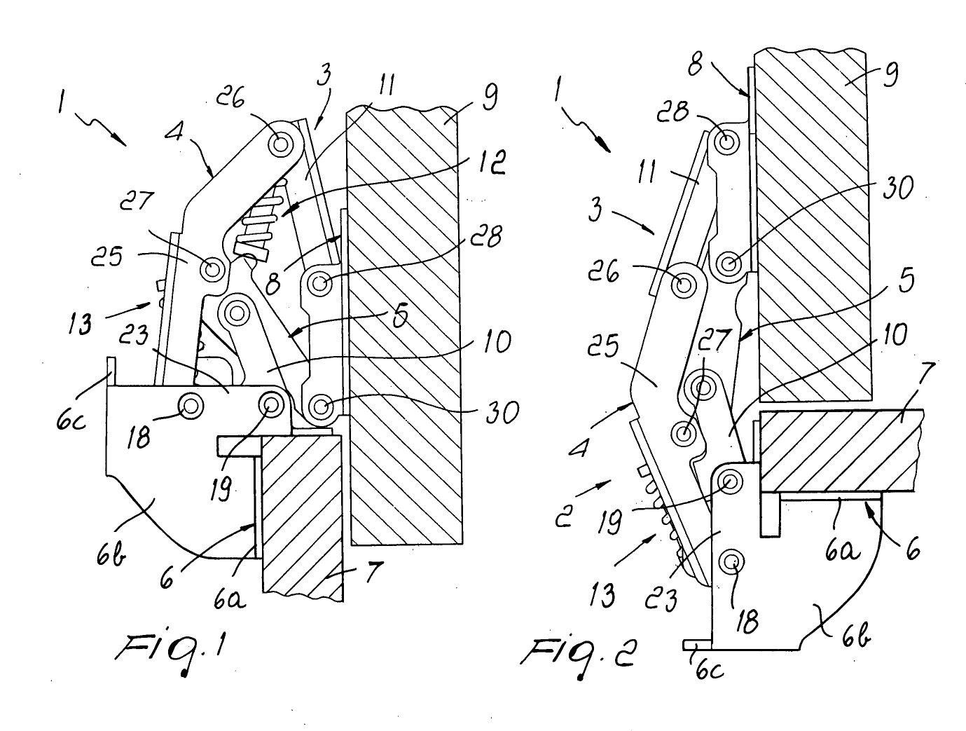

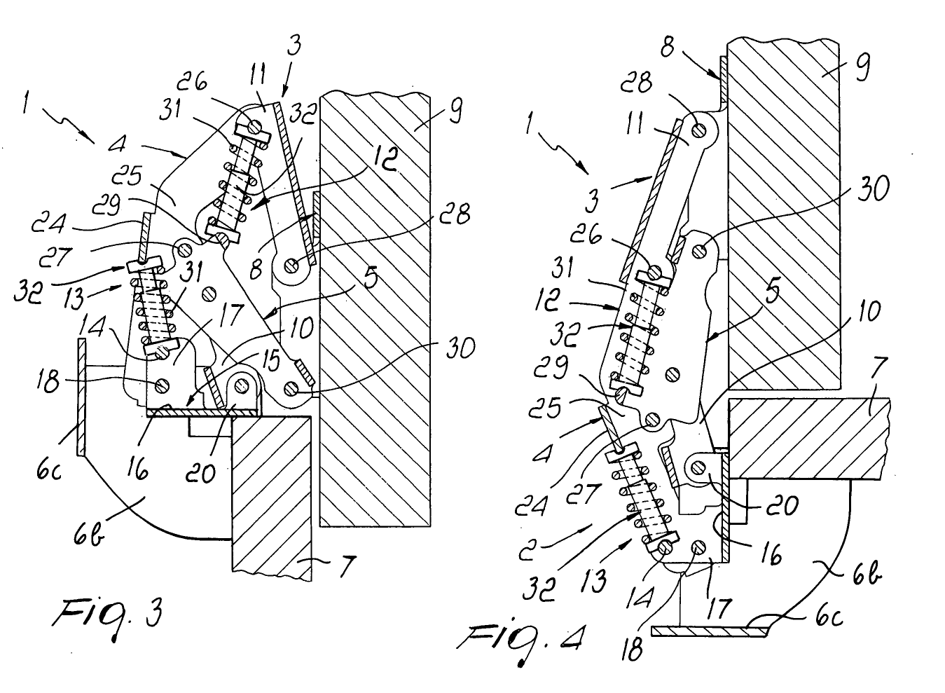

### DESCRIPTION OF THE PREFERRED EMBODIMENTS

With reference to the figures, the reference numeral 1 generally designates a snap hinge.

The hinge 1 comprises a first articulated quadrilateral 2 and a second articulated quadrilateral 3, which share a first lever 4 and a second lever 5 and have as their base element respectively a plate 6 for coupling to a fixed element 7 and a plate 8 for fixing to a closure element 9.

With reference particularly but not exclusively to cabinets for caravans or the like, the fixed element 7 is constituted by a cross-member that is fixed to the wall that delimits said cabinet in an upper region.

The cross-member, in particular, is fixed so as to be substantially perpendicular to the upper wall of the cabinet and is therefore a substantially vertical wall for coupling the hinge 1.

The fixing plate 8 is provided with slots for the passage of threaded elements for fixing to the closure element 9 or alternatively in which it is possible to provide bushes with fins, for example, made of nylon for the automatic fixing of the hinge 1 to said closure element.

The coupling plate 6 is anchored to the surface of said cross-member, which faces toward the inside of the cabinet.

The closure element 9 is instead constituted by a wing and the fixing plate 8 is anchored thereto on the surface that is designed to face the cabinet when the door is arranged in a position for closing the cabinet.

Each one of the articulated quadrilaterals 2, 3 further comprises a respective arm.

In particular, the first articulated quadrilateral 2 comprises the coupling plate 6, the first lever 4, the second lever 5 and a first arm 10, which are mutually articulated.

The second articulated quadrilateral 3 comprises the fixing plate 8, the first lever 4 and the second lever 5, and a second arm 11, which are mutually articulated.

The hinge 1 comprises elastic means 12 and auxiliary elastic means 13, which are arranged mutually in series and act respectively between a point of the first lever 4 and a point of the second lever 5 and between a point of the first lever 4 and a first pivot 14 that is supported by a supporting element 15 that is jointly associated with the coupling plate 6 and on which the end of said auxiliary elastic means that lies opposite the end associated with the first lever 4 is articulated.

For the purposes of the present invention, in particular, the supporting element 15 comprises a strip 16, which is inclined with respect to the plane of arrangement of the coupling plate 6.

In particular, in the preferred embodiment shown in the figures, the strip 16 is arranged substantially at right angles to the plane of arrangement or laying of the coupling plate 6.

In particular, the coupling plate 6 is constituted by two fixing bases 6a, which are provided with coupling slots for fixing the coupling plate 6 to the cross-member by way of threaded means or other means.

Respective sides 6b extend from the fixing bases 6a and are interconnected by a connecting element 6c, for example an offset and protruding bridge.

In particular, in the preferred embodiment shown in the figures, the strip 16 is arranged substantially at right angles to the plane of arrangement of the fixing bases 6a, i.e. the plane of arrangement or laying of the coupling plate 6.

Advantageously, the elastic means 12 are formed externally with respect to the region affected by the coupling plate 6 and in particular with respect to the region comprised between the fixing bases 6a, the sides 6b and the connecting element 6c.

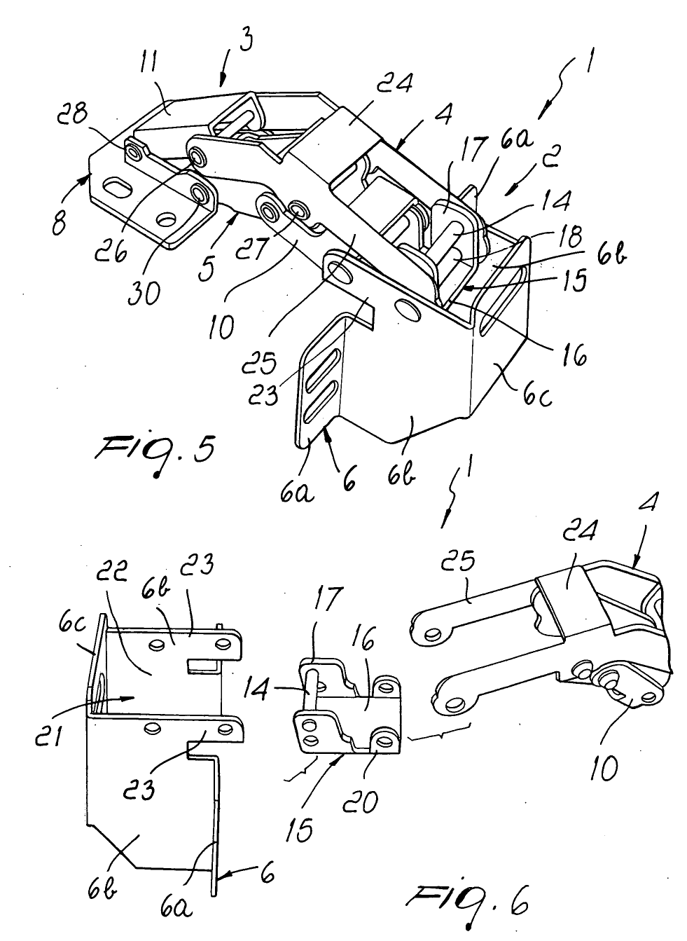

In particular, the elastic means 12 and the auxiliary elastic means 13 are formed on the same side with respect to the plane of arrangement of the fixing plate 8 and of the strip 16, which in the preferred embodiment shown in FIGS. 2, 4 and 5 are mutually coplanar, and on the opposite side with respect to the coupling plate 6 and in particular of the fixing bases 6a.

In this manner, the coupling plate 6 can have any shape and size independently of the elastic means 12, and in particular can have reduced space occupations in order to reduce the space occupation of the fixed element 7 for greater opening of the cabinet.

The supporting element 15 further comprises a pair of first flaps 17 provided so as to protrude from the two opposite edges of the strip 16 and provided with holes for supporting the opposite axial ends of the first pivot 14.

A second pivot 18 and a third pivot 19 are further associated with the supporting element 15 for the articulation respectively of an end of the first lever 4 and of an end of the first arm 10.

In particular, the pair of first flaps 17 has further, additional holes adapted to support the axial ends of the second pivot 18.

Two second flaps 20 protrude from the two opposite edges of the strip 16 and have respective additional holes adapted to support the axial ends of the third pivot 19.

Advantageously, the second and third pivots 18, 19 are substantially parallel to the first pivot 14.

The supporting element 15 is arranged inside an appropriately provided receptacle 21 that is formed proximate to, particularly is comprised by, the coupling plate 6 and comprises an opening 22. Two substantially mutually parallel side walls 23 protrude along two edges that delimit the opening 22, support the strip 16 and are formed for example monolithically with the sides 6b of the coupling plate 6.

In particular, each one of the two side walls 23 is provided with two holes that substantially correspond to the other holes and the additional holes, respectively, of the first and second pair of flaps 17 and 20, and are suitable for the insertion of the opposite ends respectively of the second pivot 18 and of the third pivot 19.

Advantageously, the second and third pivots 18 and 19 have a head-shaped end and a riveted opposite end.

The first lever 4 comprises a dorsal bridge 24, which is formed monolithically by the opposite edges of two side walls 25 that are substantially mutually parallel.

The side walls 25 have, at one end, holes that are suitable for the insertion of the axial ends of the second pivot 18 for articulation on the supporting element 15. At the opposite end, the side walls 25 have holes for articulation to the second arm 11 on a fourth pivot 26. A fifth pivot 27 is supported by holes that are formed on the side walls 25 proximate to the dorsal bridge 24, and the second lever 5 is articulated around it.

The edge of the dorsal bridge 24 directed toward the coupling plate 6 forms an articulation point of the end of the auxiliary elastic means 13 that lies opposite the end that is articulated to the first pivot 14.

The second arm 11 is articulated, at its end that lies opposite the one articulated to the first lever 4, to the fixing plate 8 about a sixth pivot 28.

The second lever 5 comprises, proximate to its end that is articulated to the first lever 4, a tab 29; the elastic means 12 act between the tab 29 and the fourth pivot 26.

At the opposite end, the second lever 5 is articulated to a seventh pivot 30, which is supported by the fixing plate 8 and is substantially parallel to the sixth pivot 28.

The elastic means 12 and the auxiliary elastic means 13 each comprise at least one spring 31 and two guiding elements 32 of the spring 31, which are coupled so that they can slide axially with respect to each other internally and/or externally with respect to said spring.

In particular, the elastic means 12 and the auxiliary elastic means 13 can be of the type of elastic telescopic cartridges and the two guiding elements are constituted respectively by bottoms and covers between which the spring of the helical type is contained and acts.

As an alternative, in the preferred embodiment shown, the guiding elements 32 are constituted by a cylinder and a piston, which are connected slidingly to each other at one end and are provided with heads at the respective opposite ends. The spring 31 is of the helical type and is fitted coaxially and externally on the cylinder and on the piston and acts between the two heads. This particular configuration of the elastic means 12 and of the auxiliary elastic means 13 allows a targeted sizing of the springs 31, which can have different constructive dimensions and can have reduced mechanical wear of said springs and of the pistons that are articulated to the respective pivots.

In practice it has been found that the described invention achieves the intended aim and objects, and in particular the fact is stressed that the hinge thus provided is easy to use and at the same time has a reduced space occupation.

The hinge thus provided in fact allows stable and safe support of a closure element with respect to the structure of a piece of furniture or the like both in a closed configuration and in an open configuration of the hinge, while limiting the structural complexity thereof and at the same time reducing its space occupation.

Further, it has been observed that the hinge according to the invention has good two-dimensional compactness and at the same time is suitable for fixing to the fixed element when said fixed element is constituted by the cross-member that is fixed to the wall that delimits said cabinet in an upper region.

Finally, the snap hinge as described above has a simple structure which is relatively easy to provide in practice, safe in use, effective in operation, and of relatively low cost.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to requirements without thereby abandoning the scope of the protection of the appended claims.

The disclosures in Italian Patent Application No. M02008A000087 from which this application claims priority are incorporated herein by reference.

What is claimed is:

1. A snap hinge for supporting a closure element adapted to turn with respect to a fixed element comprising: a first articulated quadrilateral; a second articulated quadrilateral, said first and second quadrilaterals sharing a first lever and a second lever, said first and second levers having as a base element, respectively a plate, for coupling to the fixed element and a plate for fixing to the closure element; elastic means which elastically act between a point of said first lever and a point of said second lever; a supporting element that is jointly associated with said fixing plate; and auxiliary elastic means which are arranged in series to said elastic means and have an end that is articulated to said first lever and an opposite end that is articulated to a first pivot that is supported by said supporting element, said supporting element comprising at least one strip and one pair of first flaps that are formed so as to protrude from two opposite edges of said strip and are provided with holes that support opposite ends of said first pivot, said strip being substantially inclined with respect to a plane of arrangement of said coupling plate.

2. The hinge of claim 1, wherein said strip is arranged substantially at right angles to the plane of arrangement of said coupling plate.

3. The hinge of claim 1, comprising at least one second pivot, on which said first lever is articulated, that is supported by said supporting element, said pair of first flaps having additional holes that support opposite ends of said second pivot, said first pivot and said second pivot being substantially parallel to each other.

4. The hinge of claim 3, comprising at least one third pivot on which an end of an arm of said first articulated quadrilateral is articulated, said third pivot being supported by said supporting element.

5. The hinge of claim 4, wherein said supporting element comprises a pair of second flaps that are formed so as to protrude from said two opposite edges of said strip and are provided with additional holes that support opposite ends of said third pivot, said first pivot and said third pivot being substantially parallel to each other.

6. The hinge of claim 5, wherein said coupling plate comprises at least one receptacle that accommodates said supporting element.

7. The hinge of claim 6, wherein said receptacle comprises at least one opening provided with two edges along which two substantially mutually parallel side walls are formed, and wherein each one of said side walls is provided with a pair of holes that are arranged so as to substantially correspond to said further holes and said additional holes, respectively of said pair of first flaps and of said pair of second flaps, the opposite ends, respectively, of said second pivot and said third pivot being inserted in said pair of holes, and said plate being anchored to said side walls.

8. The hinge of claim 5, wherein said first lever comprises: two side walls, which are substantially parallel to each other; a further pivot for mutual pivoting between said first lever and said second lever; a dorsal bridge that is jointly associated with said side walls and is formed proximate to said fourth pivot, an edge of said dorsal bridge directed toward said coupling plate forming an articulation point for the end of said auxiliary elastic means that lies opposite the opposite end of said auxiliary elastic means articulated to said first pivot.

9. The hinge of claim 1, wherein said auxiliary elastic means comprises at least one spring.

10. The hinge of claim 1, wherein said auxiliary elastic means comprises at least two guiding elements for guiding said spring, which are coupled to each other axially so as to be slidable with respect to each other, internally, or externally with respect to said spring.

11. The hinge of claim 10, wherein said guiding elements are mutually coupled telescopically.
